(19) United States
(12) Patent Application Publication
(10) Pub. No.: US 2022/0092416 A1
(43) Pub. Date: Mar. 24, 2022

(54) NEURAL ARCHITECTURE SEARCH THROUGH A GRAPH SEARCH SPACE

(71) Applicant: Google LLC, Mountain View, CA (US)

(72) Inventors: Neil Matthew Tinmouth Houlsby, Zurich (CH); Quentin Lascombes de Laroussilhe, Zurich (CH); Stanislaw Kamil Jastrzebski, Krakow (PL); Andrea Gesmundo, Zurich (CH)

(21) Appl. No.: 17/418,555

(22) PCT Filed: Dec. 27, 2019
(86) PCT No.: PCT/US2019/068803

§ 371 Date: Jun. 25, 2021

Related U.S. Application Data
(60) Provisional application No. 62/785,683, filed on Dec. 27, 2018.

(51) Int. Cl. G06N 3/08; G06N 3/04

(52) U.S. Cl. CPC G06N 3/08; G06N 3/0445; G06N 3/0454

(57) ABSTRACT

Methods, systems, and apparatus, including computer programs encoded on computer storage media, for determining neural network architectures. One of the methods includes receiving training data for training a task neural network to perform a particular machine learning task; and selecting, from a space of possible architectures, an architecture for the task neural network, wherein the space of possible architectures is represented as a graph of nodes connected by edges, each node in the graph representing a decision point in selecting the architecture and each edge in the graph representing an action.

### CROSS-REFERENCE TO RELATED APPLICATION

This application claims priority to U.S. Patent Application No. 62/785,683, filed Dec. 27, 2018, the entirety of which is herein incorporated by reference.

### BACKGROUND

This specification relates to determining architectures for neural networks.

Neural networks are machine learning models that employ one or more layers of nonlinear units to predict an output for a received input. Some neural networks include one or more hidden layers in addition to an output layer. The output of each hidden layer is used as input to the next layer in the network, i.e., the next hidden layer or the output layer. Each layer of the network generates an output from a received input in accordance with current values of a respective set of parameters.

Some neural networks are recurrent neural networks. A recurrent neural network is a neural network that receives an input sequence and generates an output sequence from the input sequence. In particular, a recurrent neural network can use some or all of the internal state of the network from a previous time step in computing an output at a current time step. An example of a recurrent neural network is a long short term (LSTM) neural network that includes one or more LSTM memory blocks. Each LSTM memory block can include one or more cells that each include an input gate, a forget gate, and an output gate that allow the cell to store previous states for the cell, e.g., for use in generating a current activation or to be provided to other components of the LSTM neural network.

### SUMMARY

This specification describes a system implemented as computer programs on one or more computers in one or more locations that determines an architecture for a task neural network that is configured to perform a machine learning task.

Particular embodiments of the subject matter described in this specification can be implemented so as to realize one or more of the following advantages.

By determining the architecture of a task neural network using the techniques described in this specification, the system can determine a network architecture that achieves or even exceeds state of the art performance on any of a variety of particular machine learning tasks, e.g., image classification or another image processing task. Additionally, the system can determine this architecture in a manner that is much more computationally efficient than existing techniques, i.e., that consumes many fewer computational resources than existing techniques.

Neural architecture search (NAS) is a process in which one or more neural networks are used to design another neural network, i.e., to determine an architecture for the other neural network. However, many existing techniques rely on (architecture) search spaces that are defined as a static sequence of decisions and a set of available actions for each decision, where each possible sequence of actions defines an architecture of a neural network.

The described techniques on the other hand, make use of a graph search space. Thus the sequence of decisions defining an architecture is not fixed, but is determined dynamically by the actions selected at each decision. Thus, the dynamic controller for the neural architecture search is not required to visit all the states in the search space when generating any given candidate architecture. Because of this, the system can improve the sample efficiency and stability of the training of the controller neural network and, consequently, the architecture search process. In particular, the controller neural network may visit fewer states (or nodes), easing credit assignment (assignment of “credit” to the nodes for a particular performance outcome) during training. Additionally, in some cases, gradient updates are performed only for relevant actions and nodes that are relevant to the generated model (i.e. the nodes and actions within the path defining or representing the architecture and not for nodes and actions in the graph that are not within the path defining the architecture). This reduces the variance of the reinforcement learning technique being used in the training of the controller and therefore decreases training time and increases training quality of the controller, consequently decreasing the time required by the controller neural network for the search process and improving the quality of the final task neural network architecture.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 shows an example neural architecture search system.

FIG. 2 shows an example search space.

FIG. 3 shows an example architecture of the controller neural network.

FIG. 4 is a flow diagram of an example process for selecting a final architecture.

FIG. 5 is a flow diagram of an example process for generating a path through the graph.

Like reference numbers and designations in the various drawings indicate like elements.

### DETAILED DESCRIPTION

This specification describes a system implemented as computer programs on one or more computers in one or more locations that determines a network architecture for a task neural network that is configured to perform a particular machine learning task.

In some cases, the task neural network is a convolutional neural network that is configured to receive an input image and to process the input image to generate a network output for the input image, i.e., to perform some kind of machine learning image processing task. For example, the particular machine learning task may be image classification and the output generated by the neural network for a given image may be scores for each of a set of object categories, with each score representing an estimated likelihood that the image contains an image of an object belonging to the category. As another example, the particular machine learning task can be image embedding generation and the output generated by the neural network can be a numeric embedding of the input image. As yet another example, the particular machine learning task can be object detection and the output generated by the neural network can identify locations in the input image at which particular types of objects are depicted.

As another example, if the inputs to the task neural network are Internet resources (e.g., web pages), documents, or portions of documents or features extracted from Internet resources, documents, or portions of documents, the particular machine learning task can be to classify the resource or document (“resource classification”), i.e., the output generated by the task neural network for a given Internet resource, document, or portion of a document may be a score for each of a set of topics, with each score representing an estimated likelihood that the Internet resource, document, or document portion is about the topic.

As another example, if the inputs to the task neural network are features of an impression context for a particular advertisement, the output generated by the task neural network may be a score that represents an estimated likelihood that the particular advertisement will be clicked on.

As another example, if the inputs to the task neural network are features of a personalized recommendation for a user, e.g., features characterizing the context for the recommendation, e.g., features characterizing previous actions taken by the user, the output generated by the task neural network may be a score for each of a set of content items, with each score representing an estimated likelihood that the user will respond favorably to being recommended the content item.

As another example, if the input to the task neural network is a sequence of text in one language, the particular machine learning task may be translation, i.e. the output generated by the task neural network may be a score for each of a set of pieces of text in another language, with each score representing an estimated likelihood that the piece of text in the other language is a proper translation of the input text into the other language.

As another example, if the input to the task neural network is a sequence representing a spoken utterance, the particular machine learning task may be transcription, i.e. the output generated by the task neural network may be a score for each of a set of pieces of text, each score representing an estimated likelihood that the piece of text is the correct transcript for the utterance.

As another example, the task may be an audio processing task. For example, if the input to the neural network is a sequence representing a spoken utterance, the output generated by the neural network may be a score for each of a set of pieces of text, each score representing an estimated likelihood that the piece of text is the correct transcript for the utterance. As another example, if the input to the neural network is a sequence representing a spoken utterance, the output generated by the neural network can indicate whether a particular word or phrase (“hotword”) was spoken in the utterance. As another example, if the input to the neural network is a sequence representing a spoken utterance, the output generated by the neural network can identify the natural language in which the utterance was spoken.

As another example, the particular task can be a natural language processing or understanding task, e.g., an entailment task, a paraphrase task, a textual similarity task, a sentiment task, a sentence completion task, a grammaticality task, and so on, that operates on a sequence of text in some natural language.

As another example, the particular task can be a text to speech task, where the input is text in a natural language or features of text in a natural language and the network output is a spectrogram or other data defining audio of the text being spoken in the natural language.

As another example, the particular task can be a health prediction task, where the input is electronic health record data for a patient and the output is a prediction that is relevant to the future health of the patient, e.g., a predicted treatment that should be prescribed to the patient, the likelihood that an adverse health event will occur to the patient, or a predicted diagnosis for the patient.

As another example, the particular task can be an agent control task, where the input is an observation characterizing the state of an environment and the output defines an action to be performed by the agent in response to the observation. The agent can be, e.g., a real-world or simulated robot, a control system for an industrial facility, or a control system that controls a different kind of agent.

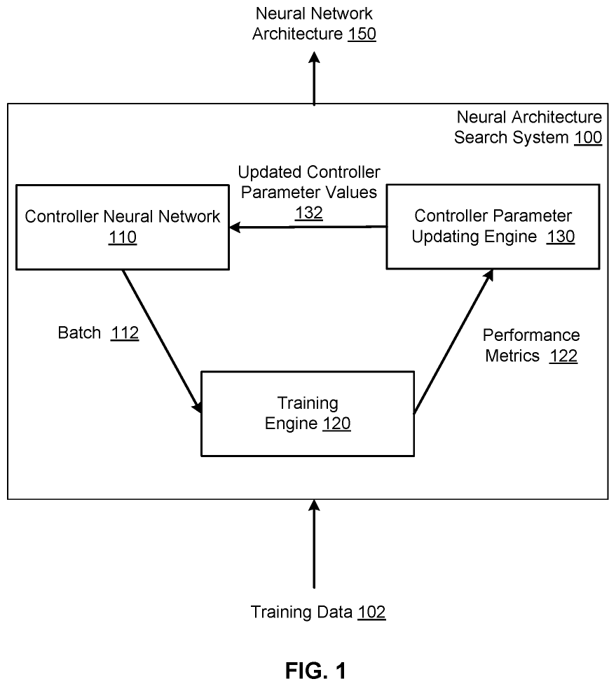

FIG. 1 shows an example neural architecture search system 100. The neural architecture search system 100 is an example of a system implemented as computer programs on one or more computers in one or more locations, in which the systems, components, and techniques described below can be implemented.

The neural architecture search system 100 is a system that obtains training data 102 for training a neural network to perform a particular task and a validation set for evaluating the performance of the neural network on the particular task and uses the training data 102 and the validation set to determine an architecture for a task neural network that is configured to perform the particular task.

Generally, the training data 102 and the validation set 104 both include a set of neural network inputs and, for each network input, a respective target output that should be generated by the task neural network to perform the particular task. For example, a larger set of training data may have been randomly partitioned to generate the training data 102 and the validation set 104. In some cases, the larger set of training data is dynamically partitioned into training data and validation data each time that a candidate architecture needs to be evaluated. Additionally, in some cases, there is some degree of overlap between the network inputs in the training data and the validation data, i.e., some portion of the network inputs in the training data are also in the validation data.

The system 100 can receive the training data 102 and the validation set 104 in any of a variety of ways. For example, the system 100 can receive training data as an upload from a remote user of the system over a data communication network, e.g., using an application programming interface (API) made available by the system 100, and randomly divide the uploaded data into the training data 102 and the validation set 104. As another example, the system 100 can receive an input from a user specifying which data that is already maintained by the system 100 should be used for training the neural network, and then divide the specified data into the training data 102 and the validation set 104.

The system 100 selects or determines the architecture of the task neural network from a space of possible architectures for the task neural network, i.e., a search space defining or representing possible architectures.

The search space of possible architectures for the task neural network is represented as a graph of nodes connected by edges. Each node in the graph represents a decision point in selecting the architecture and each edge in the graph represents an action. In particular, the actions represented by outgoing edges from a given node are the possible decisions that can be made at the decision point represented by the given node. Each path through the graph that starts at an initial node in the graph and ends at a terminal node in the graph determines or represents an architecture for the task neural network.

In particular, each decision point determines (at least in part) the value of some hyperparameter of the candidate architecture of the task neural network; edges from the decision point can represent available hyperparameter values for the decision point. Generally, a hyperparameter is a value that is set prior to the commencement of the training of the task neural network and that impacts the operations performed by the task neural network or in training of the task neural network.

The hyperparameters can include any values that impact any of: the number of layers in the task neural network, the operations performed by a given layer in the neural network (the type of layer (e.g., convolutional or fully-connected or max pooling or average pooling), the number of filters for a convolutional layer, dimension of each filter, type of convolution, number of hidden units for a fully connected layer, dimensionality of hidden state for a recurrent neural network layer), the connectivity between any two layers in the neural network (e.g., which layer or layers receive the output generated by a given layer, whether a skip or residual connection is included between two layers, and so on), and hyperparameters of the training process (e.g., the optimizer used in the training, the update rule parameters used by the selected optimizer, the weight between different terms in the objective function being trained, and so on).

As a general example, one node in the graph can represent a decision point that determines whether to add another layer to the architecture and the outgoing edges from that node can include a first edge that corresponds to adding a layer and a second edge that corresponds not adding a layer. A node connected by the first outgoing edge from the first node can represent a decision that determines what type of layer the new layer is, and another node connected by the second edge to the first node can be a terminal node that indicates that the architecture is finalized because no more layers are to be added.

Thus, when generating a path through the graph, each edge in the path is a value for a different hyperparameter and the path defines a candidate architecture for the task neural network by specifying the values (edges) for the hyperparameters at each decision point.

The neural architecture search system 100 includes a controller neural network 110, a training engine 120, and a controller parameter updating engine 130.

The controller neural network 110 is a neural network that has parameters (for example, weights and biases), referred to in this specification as “controller parameters,” and that is configured to generate outputs that define paths through the graph in accordance with the controller parameters, which paths correspond to candidate architectures for a task neural network. In this way, the controller neural network is a “generative” neural network which controls the generation of different candidate task neural networks. In particular, for each node in the path, the controller neural network 110 processes a controller input for the node to generate a score distribution over the actions represented by outgoing edges from the node. The system 100 then samples an action from the score distribution. If the node is not a terminal node, the system 100 adds, to the path, the node that is connected to by the outgoing edge represented by the sampled action. The outgoing edges for terminal nodes do not connect to any other nodes in the graph and the system therefore terminates the path after sampling the action for the terminal node.

Each path generated using the controller neural network 110 defines a respective possible architecture for the task neural network.

Generally, the system 100 determines the final architecture for the task neural network by training the controller neural network 110 to iteratively adjust the values of the controller parameters. At each iteration, the controller neural network can generate one or more paths, each representing an architecture to be trained and evaluated, and the controller parameters can be updated or adjusted based on the results of each evaluation. In this way, the controller neural network can be used to design an improved task neural network for a specific task, such as image classification or other forms of image processing.

In particular, during an iteration of the training procedure, the system 100 generates a batch of paths 112 using the controller neural network 110 in accordance with current values of the controller parameters.

For each output sequence (or path) in the batch 112, the training engine 120 trains an instance of the task neural network (that has the architecture defined, or represented, by the path) on the training data 102 and evaluates the performance of the trained instance on the validation set 104.

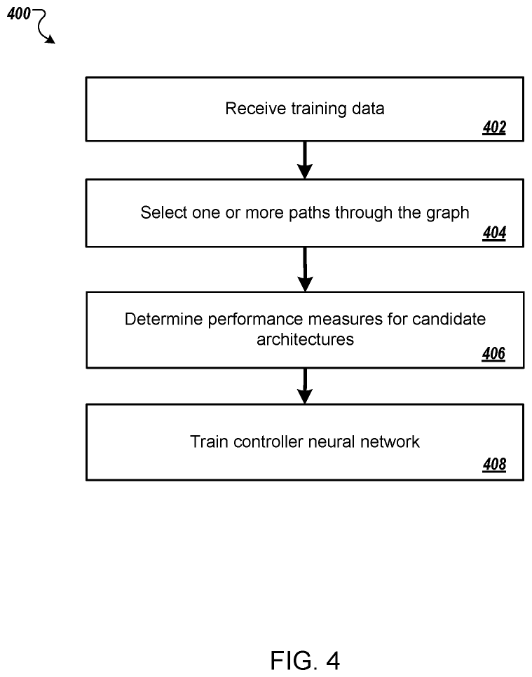

The controller parameter updating engine 130 then uses the results of the evaluations for the paths in the batch 112 to update the current values of the controller parameters to improve the expected performance of the architectures defined by the paths generated by the controller neural network 110 on the task. Evaluating the performance of trained instances and updating the current values of the controller parameters is described in more detail below with reference to FIG. 4.

By repeatedly updating the values of the controller parameters in this manner, the system 100 can train the controller neural network 110 to generate new paths that result in task neural networks that have increased performance on the particular task, i.e., to maximize the expected accuracy on the validation set of the architectures proposed by the controller neural network 110.

Once the controller neural network 110 has been trained, the system 100 can select the architecture that had the best (for example, highest) performance measure as the final architecture of the task neural network or can generate a new path through the search space in accordance with the trained values of the controller parameters (i.e. using the trained controller neural network) and use the architecture defined by the new path as the final architecture of the task neural network.

The neural network search system 100 can then output architecture data 150 that specifies the architecture of the task neural network, i.e., data specifying the layers that are part of the task neural network, the connectivity between the layers, and the operations performed by the layers. For example, the neural network search system 100 can output the architecture data 150 to the user that submitted the training data. In some cases, the data 150 also includes trained values of the parameters of the task neural network from the training of the trained instance of the task neural network that had the architecture.

In some implementations, instead of or in addition to outputting the architecture data 150, the system 100 trains an instance of the neural network having the determined architecture, e.g., either from scratch or to fine-tune the parameter values generated as a result of training the instance of the task neural network having the architecture, and then uses the trained neural network to process requests received by users, e.g., through the API provided by the system. That is, the system 100 can receive inputs to be processed, use the trained task neural network to process the inputs to perform the particular machine learning task, and provide the outputs generated by the trained neural network or data derived from the generated outputs in response to the received inputs.

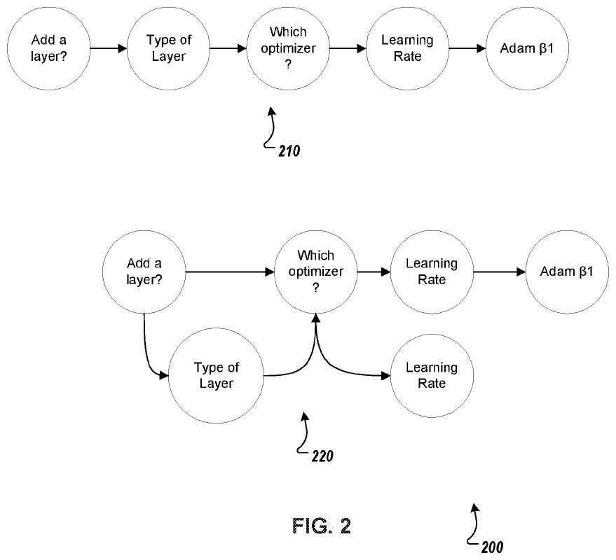

FIG. 2 shows an example search space (representing or defining possible architectures) that can be searched by the neural architecture search system 100 to select, or determine, an architecture for the task neural network.

In particular, FIG. 2 shows two search spaces 210 and 220 that each allow the system to determine whether to add a layer to the architecture and what optimization scheme to use during training of the neural network having the architecture. For example, the optimization scheme can be selected from two possible choices, e.g., the Adam optimizer or the rmsProp optimizer.

The search space 210 represents this as a linear search space that requires a fixed number of decisions to be made in sequence, i.e., in a fixed order, and is an example of a search space that is searched by conventional neural architecture search techniques.

In particular, in the search space 210, the selection proceeds according to the following order: 1) the system selects whether to add a layer or not, 2) the system selects the type of layer to be added, 3) the system selects which optimizer is used to during training, 4) the system selects the learning rate for optimized, and, finally, 5) the system selects the value for a hyperparameter B1 of the Adam optimizer. It should be noted that although step 5) is only applicable when the optimizer selected is Adam in step 3), due to the sequential nature of the search space the system is nonetheless required to make a decision at step 5) even if Adam is not selected as the optimizer at step 3). Similarly, step 2) is only applicable when the system determines to add a layer at step 1), but the system nonetheless makes a decision at step 2) even when the decision has no impact on the final architecture because the system determined to not add a layer at step 1).

The search space 220 represents the decision points in generating the architecture as a graph. As can be seen from the search space 220, the search space 220 is represented as a graph with two terminal decision points: selecting the learning rate if the optimizer selected is not Adam and selecting the value for B1 if the optimizer selected is Adam. Because of this graph representation, the controller neural network is not required to make unnecessary decisions (e.g. if the system determines not to use Adam, the system does not have to select a value for the B1 hyperparameter), and iterative and branching architecture design decisions can be introduced; higher accuracy or performance measures may therefore be attained. Moreover, the graph search space may improve training speed, improving convergence speed as compared to a linear search space. The graph search space based approach described herein can also improve the sample efficiency of the training of the controller neural network and, consequently, the architecture search process. A final task neural network architecture may therefore be determined in a quicker and more computationally efficient manner. Additionally, the choice of learning rate can be represented by two separate nodes, one for each optimizer that is selected. This can ease the learning of credit assignment during training of the controller neural network.

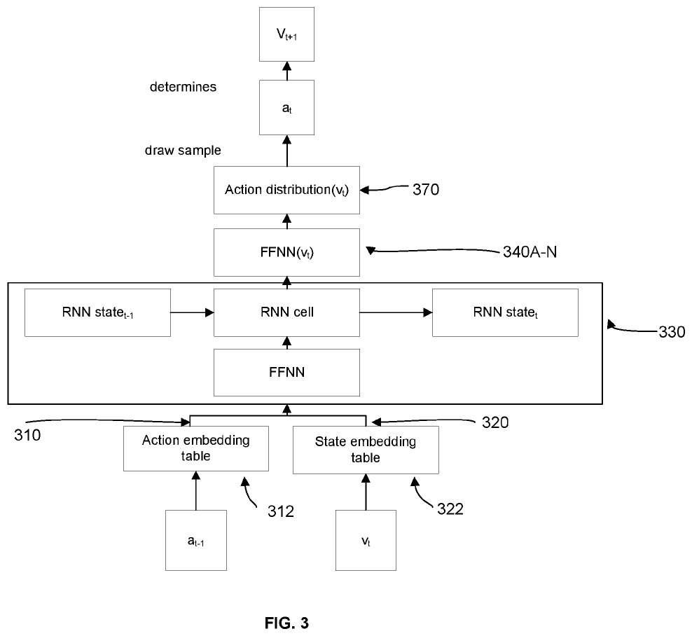

FIG. 3 shows an example architecture 300 for the controller neural network 110.

When selecting an outgoing edge from any particular node that is in a path through the graph, the controller neural network 110 is configured to process a controller input that characterizes the decision point represented by the particular node to generate a score distribution 370 that includes a respective score for each of the outgoing edges from the particular node.

In the example of FIG. 3, the controller input includes an action embedding 310 of the action aₜ₋₁ represented by the outgoing edge connecting the particular node to the previous node in the path and a state embedding 320 of the decision point vₜ represented by the particular node. For example, the controller input can be a concatenation of the action embedding 310 and the state embedding 320.

The system can generate the action embedding 310 by mapping the action aₜ₋₁ to the action embedding 310 using an action embedding table 312 and can generate the state embedding 320 by mapping the decision point vₜ to the state embedding 320 using a state embedding table 322.

An embedding, as used in this specification, is an ordered collection of numeric values, e.g., a vector of floating point or other numeric values, having a fixed dimensionality. An embedding table stores a mapping between inputs and the corresponding embeddings for those inputs. The embeddings in the action embedding table 312 and the state embedding table 322 can be randomly initialized or initialized to default values and then learned jointly with the training of the controller neural network 110.

The controller neural network 110 includes a timestep independent neural network 330 and a respective timestep dependent neural network 340A-N for each node in the graph. The timestep independent neural network 330 is referred to as “timestep dependent” because it is shared by all of the nodes in the graph, i.e., the same neural network 330 is used for all of the nodes in the graph. The time step dependent neural networks 340A-N are referred to as “timestep dependent” because each neural network 340A-340N corresponds to a different one of the nodes in the graph and is only used, i.e., is only active, when the particular node is the corresponding node for the neural network 340A-340N. Thus, while the timestep independent neural network 330 is active when selecting an outgoing edge from any node in the graph, each timestep dependent neural network 340A-340N is only active when selecting an outgoing edge from the corresponding node for the timestep dependent neural network.

The timestep independent neural network 330 generally receives the controller input and processes the controller input to generate an alternative representation of the controller input.

The timestep dependent neural network 340A-340N corresponding to the particular node then receives the alternative representation and processes the alternative representation to generate the score distribution 370 that includes a respective score for each outgoing edge from the particular node. Because different nodes may have different numbers of outgoing edges, different timestep dependent neural networks 340A-340N may generate score distributions that include different numbers of scores.

In some implementations, to allow the system to condition the selections at a given decision point on the processing that has already been performed at any earlier decision points along the path, the timestep independent neural network 330 is a recurrent neural network (RNN), i.e., a neural network that includes one or more recurrent neural network layers that maintain an RNN state and update that RNN state for each decision point as part of generating the alternative representation. In the particular example of FIG. 3, the timestep independent neural network 330 includes one or more feedforward neural network layers (FFNN) prior to the one or more RNN layers (denoted in the figure as an “RNN cell”). For example, the one or more RNN layers can include one or more long short-term memory (LSTM) layers or other kinds of RNN layers, e.g., vanilla RNN layers or gated recurrent units (GRUs). The FFNN layers can be a fully-connected neural network that aggregates the embeddings before the aggregated representation of the embeddings is provided as input to the RNN layers.

Each timestep dependent neural network 340A-N can include also include one or more FFNN layers that map the alternative representation to the score distribution.

Once the timestep dependent neural network 340A-N corresponding to the node that represents the decision point vₜ has generated the score distribution, the system samples an action from the generated score distribution to generate an action aₜ, which leads to the next decision point in the path vₜ₊₁. That is, the system adds, to the path, the node that is connected to by the outgoing edge that represents the action aₜ.

By repeatedly selecting actions in this manner, the system can generate a path through the graph that terminates at one of the terminal nodes in the graph. A terminal node in the graph is one whose outgoing edges do not connect to any other nodes in the graph. Each generated path thus corresponds to, or represents, a candidate architecture for the target neural network; each action, or edge, of the path defines a part of the architecture (such as a type of layer, a layer connectivity, or any other hyperparameter value), and the combination of these actions along the path defines an overall architecture.

FIG. 4 is a flow diagram of an example process 400 for selecting, or generating, a final architecture for a task neural network from a search space of possible architectures. For convenience, the process 400 will be described as being performed by a system of one or more computers located in one or more locations. For example, a neural architecture search system, e.g., the neural architecture search system 100 of FIG. 1, appropriately programmed, can perform the process 400.

The system receives training data for a particular machine learning task (step 402) for which a task neural network is to be selected.

The system then (iteratively) searches a space of candidate architectures to select (or determine) the final architecture of the task neural network. In particular, as described above, the (search) space of possible architectures is represented as a graph of nodes connected by edges, each node in the graph representing a decision point in selecting (or determining) the architecture and each edge in the graph representing an action, i.e., a different value for the hyperparameter corresponding to the decision point.

In particular, to select the final architecture, the system repeatedly performs steps 404-408 until termination criteria for the architecture search are satisfied.

The system selects, or generates, a batch of one or more paths through the graph using the controller neural network and in accordance with current values of the controller parameters (step 404). Each of the paths in the batch defines, or represents, a candidate architecture, i.e., because each path includes a respective action for multiple decision points that collectively define the candidate architecture.

The system determines respective performance measures for each of the candidate architectures (step 406). The performance measure may be an indication of the quality of the output of a trained neural network having the architecture as compared to expected outputs for the training data or the validation data.

In particular, to determine the performance measure for a given candidate architecture that is defined by a given path, the system generates an instance of the task neural network that has the given candidate architecture.

The system then trains the instance to perform the particular machine learning task by training the instance on some or all of the received training data using a machine learning training technique that is appropriate for the task, e.g., stochastic gradient descent with backpropagation or backpropagation-through-time. When the path includes nodes that represent hyperparameters that impact training, the system performs the training in accordance with values for those hyperparameters in the path.

In some implementations, the system parallelizes the training of the instances to decrease the overall training time for the controller neural network. The system can train each instance for a specified amount of time or a specified number of training iterations or until convergence.

The system then determines a performance measure on the particular task for the trained instance. In particular, after the instance has been trained, the system evaluates the performance of the trained instance on the task to determine the performance metric.

For example, the performance metric can be an accuracy of the trained instance on the validation set, as measured by an appropriate accuracy measure. For example, the accuracy measure can be a perplexity measure when the outputs are sequences or a classification error rate when the task is a classification task. As another example, when the outputs are images, the accuracy measure can be the pixel-wise mean intersection-over-union (mIOU) of the trained instance over the validation data set. As another example, the performance metric can be an average or a maximum of the accuracies of the instance for each of the last two, five, or ten epochs of the training of the instance.

The system trains the controller neural network using the performance measures for the candidate architectures to determine an update to the current values of the controller parameters that improves the performance measures for architectures defined by paths generated by the task neural network (step 408).

In particular, the system adjusts the current values by training the controller neural network to generate paths that result in task neural networks having increased performance metrics using a reinforcement learning technique. More specifically, the system trains the controller neural network to generate paths that maximize a received reward that is determined based on the performance metrics of the trained instances. In particular, the reward for a given path is a function of the performance metric for the trained instance. For example, the reward can be one of: the performance metric, the square of the performance metric, the cube of the performance metric, the square root of the performance metric, and so on.

In some cases, the system trains the controller neural network to maximize the expected reward using a policy gradient technique. For example, the policy gradient technique can be a REINFORCE technique or a Proximal Policy Optimization (PPO) technique. For example, the system can estimate the gradient of the expected reward with respect to the controller parameters using an estimator of the gradient that satisfies:

$$\frac{1}{m} {\sum }_{k = 1}^{m} {\sum }_{t = 1}^{T} ∇ {θ}_{c} log \vert P ( {a}_{t} \vert {a}_{( t - 1 ) 1} ; {θ}_{c} ) ( {R}_{k} - b ) ,$$

where m is the number of paths in the batch, T is the number of time steps in the k-th path in the batch, aₜ is the action sampled at time step tin a given path, Rₖ is the reward for path k, θ_{c} are the controller parameters, and b is a baseline function, e.g., the exponential moving average of previous architecture accuracies. By iteratively training the controller neural network in this way, the controller neural network can be used to select, or generate, a path through the search space graph that corresponds to a final, optimized, task neural network architecture.

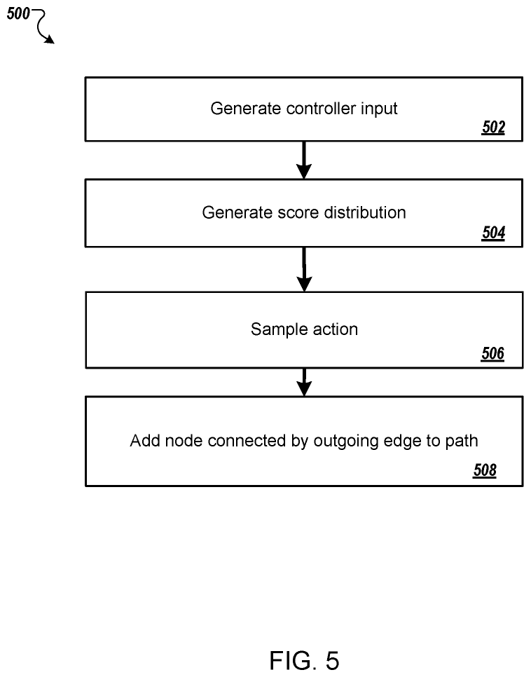

FIG. 5 is a flow diagram of an example process 500 for generating a path through the graph. For convenience, the process 500 will be described as being performed by a system of one or more computers located in one or more locations. For example, a neural architecture search system, e.g., the neural architecture search system 100 of FIG. 1, appropriately programmed, can perform the process 500.

To generate a path, the system can repeatedly perform the process 500 starting at an initial node in the graph and until the path reaches a terminal node in the graph.

The system generates a controller input for the current node (step 502). As described above, the controller input characterizes the decision point represented by the current node. For example, the controller input can include an embedding of the decision point and, optionally, an embedding of the action represented by the outgoing edge connecting the particular node to the previous node in the path.

The system process the controller input using the controller neural network and in accordance with current values of the controller parameters to generate a score distribution that includes a respective score for each action that is represented by an outgoing edge from the current node (step 504). In particular, during this processing, the system processes the controller input using the timestep independent neural network to generate an alternative representation and then only processes the alternative representation using the timestep dependent neural network that corresponds to the decision point represented by the current node (and not using any of the other timestep dependent neural networks) to generate the score distribution.

The system samples an action from the score distribution (step 506). In other words, the system selects the action, where the likelihood that each action is selected is defined by the score assigned to that action in the score distribution. When the scores are probabilities, the system samples the action by sampling from the probability distribution.

The system adds, to the path, the node to which the outgoing edge representing the sampled action connects (step 508). The process is repeated, with all of the nodes being added to the path collectively defining a candidate task neural network architecture.

When the current node is a terminal node, because the outgoing edges of the terminal node do not connect to any other node in the graph, the system finalizes the path after sampling the action, i.e., does not add any more nodes to the path after the action for the terminal node is selected.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a data communication network.

In this specification, the term “database” is used broadly to refer to any collection of data: the data does not need to be structured in any particular way, or structured at all, and it can be stored on storage devices in one or more locations. Thus, for example, the index database can include multiple collections of data, each of which may be organized and accessed differently.

Similarly, in this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework, a Microsoft Cognitive Toolkit framework, an Apache Singa framework, or an Apache MXNet framework.

Embodiments of the subject matter described in this specification can be implemented in a computing system that includes a back end component, e.g., as a data server, or that includes a middleware component, e.g., an application server, or that includes a front end component, e.g., a client computer having a graphical user interface, a web browser, or an app through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

1. A method performed by one or more computers, the method comprising:
receiving training data for training a task neural network to perform a particular machine learning task; and
selecting, from a space of possible architectures, an architecture for the task neural network, wherein the space of possible architectures is represented as a graph of nodes connected by edges, each node in the graph representing a decision point in selecting the architecture and each edge in the graph representing an action, the selecting comprising repeatedly performing the following:
selecting, using a controller neural network having a plurality of controller parameters and in accordance with current values of the controller parameters, one or more paths through the graph, each path comprising a plurality of nodes that are each connected by an edge to at least one other node in the path, and each path defining a candidate architecture for the task neural network;
for each selected path:
generating an instance of the task neural network having the candidate architecture defined by the path;
training the instance to perform the particular machine learning task; and
determining, for the trained instance, a performance measure on the particular task; and
training the controller neural network using the performance measures for the candidate architectures to determine an update to the current values of the controller parameters that improves the performance measures for architectures defined by paths generated by the task neural network.

2. The method of claim 1, further comprising:
training a task neural network having the selected architecture; and
using the trained task neural network having the selected architecture to perform the particular machine learning task.

3. The method of claim 1, wherein the controller neural network is configured to, for any particular node in the graph:
receive a controller input characterizing at least the decision point represented by the particular node; and
process the controller input in accordance with the controller parameters to generate a score distribution comprising a respective score for each action represented by an outgoing edge from the particular node.

4. The method of claim 3, wherein selecting, using a controller neural network having a plurality of controller parameters and in accordance with current values of the controller parameters, one or more paths through the graph, comprises, for each of the one more paths:
at each particular node in the path starting at an initial node in the graph and continuing until the path reaches a terminal node in the graph:
generating a controller input characterizing the decision point represented by the particular node;
processing controller input using the controller neural network and in accordance with the current values of the controller parameters to generate a score distribution comprising a respective score for each action represented by an outgoing edge from the particular node;
sampling an action from the score distribution; and
adding, to the path, the node to which the outgoing edge representing the sampled action connects.

5. The method of claim 3, wherein the controller input comprises an embedding of the decision point represented by the particular node.

6. The method of claim 3, wherein the controller input comprises an embedding of an action represented by the outgoing edge connecting the particular node to the previous node in the path.

7. The method of claim 3, wherein the controller neural network comprises:
a timestep independent neural network that is shared by all of the nodes in the graph and that is configured to:
process the controller input to generate an alternative representation of the controller input; and
a plurality of timestep dependent neural networks, each timestep dependent neural network corresponding to a different node in the graph, and configured to:
process the alternative representation to generate a score distribution that includes a respective score for each action represented by an outgoing edge from the corresponding node, and wherein processing the controller input in accordance with the controller parameters to generate a score distribution comprising a respective score for each action represented by an outgoing edge from the particular node comprises:
processing the controller input using the time step independent neural network to generate the alternative representation and processing the alternative representation using the time step dependent neural network corresponding to the particular node to generate the score distribution.

8. The method of claim 7, wherein training the controller neural network using the performance measures for the candidate architectures to determine an update to the current values of the controller parameters that improves the performance metrics for architectures defined by paths generated by the neural network comprises:
determining updates for current values of the parameters of the time step independent neural network and for current values of the parameters of only those time step dependent neural networks that correspond to nodes that are included in at least one of the paths.

9. The method of claim 7, wherein the time step independent neural network comprises one or more recurrent neural network layers.

10. The method of claim 9, wherein the time step independent neural network comprises:
one or more feedforward neural network layers prior to the one or more recurrent neural network layers.

11. The method of claim 1, wherein training the controller neural network using the performance measures for the candidate architectures to determine an update to the current values of the controller parameters that improves the performance metrics for architectures defined by paths generated by the controller neural network comprises:
generating, from the performance measure for the path, a respective reward value for each path; and
training the controller neural network to generate paths that maximize expected reward values for paths generated by the controller neural network using a reinforcement learning technique.

12. The method of claim 11, wherein the reinforcement learning technique is a policy gradient technique.

13. The method of claim 1, wherein selecting the architecture for the task neural network comprises:
selecting the candidate architecture that had a highest performance measure as a final architecture for the task neural network, or
generating, using the trained controller neural network, a new path through the graph and selecting an architecture defined by the new path as the final architecture for the task neural network.

14. (canceled)

15. One or more non-transitory computer-readable storage media storing instructions that when executed by one or more computers cause the one or more computers to perform operations comprising:
receiving training data for training a task neural network to perform a particular machine learning task; and
selecting, from a space of possible architectures, an architecture for the task neural network, wherein the space of possible architectures is represented as a graph of nodes connected by edges, each node in the graph representing a decision point in selecting the architecture and each edge in the graph representing an action, the selecting comprising repeatedly performing the following:
selecting, using a controller neural network having a plurality of controller parameters and in accordance with current values of the controller parameters, one or more paths through the graph, each path comprising a plurality of nodes that are each connected by an edge to at least one other node in the path, and each path defining a candidate architecture for the task neural network;
for each selected path:
generating an instance of the task neural network having the candidate architecture defined by the path;
training the instance to perform the particular machine learning task; and
determining, for the trained instance, a performance measure on the particular task; and
training the controller neural network using the performance measures for the candidate architectures to determine an update to the current values of the controller parameters that improves the performance measures for architectures defined by paths generated by the task neural network.

16. A system comprising one or more computers and one or more storage devices storing instructions that when executed by one or more computers cause the one or more computers to perform operations comprising:
receiving training data for training a task neural network to perform a particular machine learning task; and
selecting, from a space of possible architectures, an architecture for the task neural network, wherein the space of possible architectures is represented as a graph of nodes connected by edges, each node in the graph representing a decision point in selecting the architecture and each edge in the graph representing an action, the selecting comprising repeatedly performing the following:
selecting, using a controller neural network having a plurality of controller parameters and in accordance with current values of the controller parameters, one or more paths through the graph, each path comprising a plurality of nodes that are each connected by an edge to at least one other node in the path, and each path defining a candidate architecture for the task neural network;
for each selected path:
generating an instance of the task neural network having the candidate architecture defined by the path;
training the instance to perform the particular machine learning task; and
determining, for the trained instance, a performance measure on the particular task; and
training the controller neural network using the performance measures for the candidate architectures to determine an update to the current values of the controller parameters that improves the performance measures for architectures defined by paths generated by the task neural network.

17. The system of claim 16, the operations further comprising:
training a task neural network having the selected architecture; and
using the trained task neural network having the selected architecture to perform the particular machine learning task.

18. The system of claim 16, wherein the controller neural network is configured to, for any particular node in the graph:
receive a controller input characterizing at least the decision point represented by the particular node; and
process the controller input in accordance with the controller parameters to generate a score distribution comprising a respective score for each action represented by an outgoing edge from the particular node.

19. The system of claim 18, wherein selecting, using a controller neural network having a plurality of controller parameters and in accordance with current values of the controller parameters, one or more paths through the graph, comprises, for each of the one more paths:
at each particular node in the path starting at an initial node in the graph and continuing until the path reaches a terminal node in the graph:
generating a controller input characterizing the decision point represented by the particular node;
processing controller input using the controller neural network and in accordance with the current values of the controller parameters to generate a score distribution comprising a respective score for each action represented by an outgoing edge from the particular node;
sampling an action from the score distribution; and
adding, to the path, the node to which the outgoing edge representing the sampled action connects.

20. The system of claim 18, wherein the controller input comprises an embedding of the decision point represented by the particular node.

21. The system of claim 18, wherein the controller input comprises an embedding of an action represented by the outgoing edge connecting the particular node to the previous node in the path.
